(19) United States
(12) Patent Application Publication
(10) Pub. No.: US 2025/0340709 A1
(43) Pub. Date: Nov. 6, 2025

(54) GELLING FILMS, ARTICLES CONTAINING GELLING FILMS, AND METHODS OF MAKING AND USING THE SAME

(71) Applicant: NEOGEN FOOD SAFETY US HOLDCO CORPORATION, LANSING, MI (US)

(72) Inventors: Alexi J. Young, Lansing, MI (US); Evan D. Brutinel, Lansing, MI (US); Patrick A Mach, Lansing, MI (US); DUNCAN MINCKS, Lansing, MI (US); CARI K. LINGLE, Lansing, MI (US)

(73) Assignee: NEOGEN FOOD SAFETY US HOLDCO CORPORATION, LANSING, MI (US)

(21) Appl. No.: 18/870,430

(22) PCT Filed: Jun. 5, 2023
(86) PCT No.: PCT/US2023/067933

§ 371 Date: Nov. 28, 2024

Related U.S. Application Data
(60) Provisional application No. 63/348,495, filed on Jun. 3, 2022.

(51) Int. Cl. C08J 7/04

(52) U.S. Cl. CPC C08J 7/0427; C08J 2439/06; C08J 2471/02

(57) ABSTRACT

Films comprising a pluralities of particles of a water-soluble gum and a water-soluble polymer that contacts at least part of a surface of the water soluble gum particles, at surprisingly high coat weight. Articles comprising such films on substrates. Methods of making and using such films and articles. Dispersions useful for making such films and articles.

### CROSS REFERENCE TO RELATED APPLICATIONS

This application claims priority to U.S. Application No. 63/348,495, filed on Jun. 3, 2022, the contents of which are hereby incorporated by reference in its entirety.

### FIELD OF INVENTION

The field of the invention relates generally to polymer films and the preparation and use thereof.

### BACKGROUND

U.S. Pat. No. 5,869,321 discloses thin film culture plates having medium particles comprising nutrient and a mixture of gelling agents. The gelling agents are materials such as carbohydrates and specifically a mixture of xanthan gum, locust bean gum, and guar gum.

U.S. Pat. No. 9,988,600 discloses a dry powder cell culture medium with a polymer embedded component.

U.S. Pat. No. 20,200,19431 discloses a device for differentially enumerating colonies of coliform and Escherichia coli microorganisms. The device includes a first sheet with a first cold-water soluble gelling agent adhered to the first sheet as well as a second sheet with a second cold-water soluble gelling agent adhered to the second sheet. Guar gum, polyacrylamide, locust bean gum, and agar are mentioned as gelling agents, with guar gum and xanthan gum, alone or in combination, being preferred and guar gum being exemplified.

U.S. Pat. No. 20,150,225691 teaches a method of making a flowable, agglomerated nutrient medium using a fluidized bed agglomeration chamber. A gelling agent can be included. Binders are optionally included. Of the binders, PEG, polyvinyl pyrrolidone, polyvinyl alcohol, polysaccharide, dextran, dextrins, maltodextrins, microcrystalline cellulose, HPMC, methylcellulose, starch and sugars are mentioned.

U.S. Pat. No. 10,995,356 provides culture devices for enumerating colonies of microorganisms. Cold water-soluble gelling agent, dry buffer system, dry carbon dioxide generating system, and dry oxygen scavenging reagent are disposed in a growth compartment. Gelling agents mentioned include algin, carboxymethyl cellulose, tara gum, hydroxyethyl cellulose, guar gum, locust bean gum, xanthan gum, polyacrylamide, polyurethane, and polyethylene oxides. Guar gum, locust bean gum, and xanthan gum are preferred, either individually or in combination.

Feng et al. in Journal of Food Protection Vol. 80 (7) 2017 (1117-1122) disclose experiments “to determine potential enzymatic degradation of guar gum, the gelling agent used in Petrifilm™ plates.” The article concludes that liquefier organisms can hydrolyze the guar gum, which can have “two effects on the accuracy [of enumeration] (i) liquified areas may allow motile organisms to move and multiply . . . yielding more than one colony from one cell and as a result leading to overestimation of the microbial load and (ii) the blurred areas obscure other colonies, leading to potential underestimation.”

### DETAILED DESCRIPTION OF ILLUSTRATIVE EMBODIMENTS

In this application, terms such as “a,” “an,” and “the” are not intended to refer to only a singular entity but include the general class of which a specific example may be used for illustration. The terms “a,” “an,” and “the” are used interchangeably with the phrases “at least one” and “one or more.” The phrases “at least one of’ and “comprises at least one of’ followed by a list refers to any one of the items in the list and any combination of two or more items in the list.

Terms such as “common,” “commonly,” “often,” “frequent,” and “frequently” are used to refer to features that are typically employed in the invention, but unless otherwise indicated are not meant to imply that the features so described were known or common before this disclosure.

The use of “or” means “and/or” unless stated otherwise.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

“PEO” refers to a water-soluble organic polymer having a repeating unit with the chemical formula —OCH2CH2—. PEO as used herein refers solely to the chemical structure of the polymer, and includes not only polymers known as polyethylene oxide but also polymers known as poly(ethylene glycol) or PEG, which have repeating units with the same chemical formula as polyethylene oxide but which may, but do not necessarily, have different end groups. PEO may have a variety of end groups, including without limitation hydroxy and alkoxy. When one or more of the end groups is alkoxy, the alkoxy may be C1-C4 alkoxy or commonly C1 alkoxy. A mixture of end groups is also possible. PEO is most commonly linear; however, a small amount of branching is possible.

“PVP” refers to the water soluble polymer poly(vinyl pyrrolidone).

“Total coat weight” refers to the =coat weight (g/24 in²) of a dried film comprising a water-soluble gum and a water-soluble polymer, prepared according to methods disclosed herein.

Unless otherwise noted, all particle sizes in this disclosure and the appended claims refer to average particle sizes as determined by light scattering.

Unless otherwise noted, all pH values in this disclosure and the appended claims refer to a pH value that is measured at about 20° C.

Unless otherwise noted, the molecular weights of all polymeric materials in this disclosure and the appended claims are weight average molecular weights, reported in Daltons (D) or kilodaltons (kD), as the case may be, and as determined by gel permeation chromatography in tetrahydrofuran by comparison against narrow poly(styrene) standards.

Thin film culture devices, such as those disclosed in, for example, U.S. Pat. Nos. 5,869,321, 9,988,600, and US202001943, include a substrate with a film that typically incorporates a water-soluble gum, such as guar gum, xanthan gum, or locust bean gum. These gums are commercially available in the form of particles that dissolve in water to create viscous solutions. Forming a film of the water-soluble gums on a substrate is a challenge, particularly in a manufacturing environment where films with a precisely defined coating weight have to be formed consistently and repeatedly. Current methods of forming a film of the gum involve powder coating, which is an expensive process that requires highly specialized equipment and demanding operating conditions, especially when performed on a commercial scale.

Prior to the advances described herein, solvent coating (which as used here includes coating from any dispersion of a solid in a liquid and is not limited to coating from a solution of solutes dissolved in a liquid) which is generally easier to perform repeatably on a commercial scale, was considered unacceptable. Before the advances described in this disclosure, coating aqueous solutions of high molecular weight gums at low concentrations of gum at sufficient thicknesses required a large quantity of aqueous coating liquid, which means that a large quantity of water would have had to have been removed to form a dry film Removing a large quantity of water requires a great deal of heat and time, and is therefore cost prohibitive because it slows production, requires too much energy to be expended on heating, or both. At higher concentrations, where less water could be used, the gum increases the viscosity of the coating liquid to a level where coating is not possible.

Thus, a problem to be solved can be stated as how to provide a film comprising gum that is solvent coated. A problem can alternatively be stated as how to prepare a concentrated dispersion of a gum that is of sufficiently low viscosity so as to be amenable to being used in solvent coating processes.

### Film

Briefly, a solution to one or more of those problems, as well as other problems, lies in a film comprising a plurality of a water-soluble gum particles and a water-soluble polymer that contacts at least a part of a surface of the water-soluble gum particles, as well as in the method of making the film, articles comprising the film, and methods of using the film.

Any water-soluble gum may be used, regardless of whether the gum swells upon contact with water. Without wishing to be limited by any particular theory, the gum is able to swell, and may gel, when it is contacted with water (e.g., when the quantity of water used is insufficient to dissolve the all or part of the gum). Most commonly, the gum is a natural gum though synthetic gums could also be employed. The most commonly used gums are xanthan gum, locust bean gum, and guar gum, as well as mixtures thereof. Guar gum is most frequently employed.

The gum is in the form of a particle. Gum particles are commercially available, for example, under the trade designation MEYPROGAT (Danisco, Switzerland) and VISCOGUM (Cargill, MN, USA). In principle, the particle size of the gum is limited only by its ability to form a film, such as by the methods described herein. In some embodiments, the particle size may be about 25 to about 200 microns. In further embodiments, the particle size may be about 25 to about 200 microns, about 50 to about 175 microns, about 75 to about 150 microns, or about 100 to about 125 microns.

In principle, any water-soluble polymer can be used, though most commonly the water-soluble polymer is a synthetic polymer. In some cases, it is advantageous for the water-soluble polymer to also be soluble in a solution of water and a water-soluble (or, in some cases even more advantageously, water-miscible) organic solvent, because such solutions (i.e., solutions of water-soluble polymer in water and water-soluble, and particularly water-miscible, organic solvent) are more convenient to employ in the context of this disclosure than solutions of water-soluble polymer in water alone. Thus, most water-soluble polymers used are water-soluble polymers that are also soluble in a mixture of water and at least one water-soluble, and more particularly water-miscible, organic solvent. The water-miscible organic solvent mentioned can be selected from the group consisting of isopropanol, ethanol, methanol, tetrahydrofuran, diethyl ether, methyl ethyl ether, dimethyl ether, and acetone. More commonly, the water-miscible organic solvent is selected from the group consisting of isopropanol, ethanol, and methanol. Most frequently, the water-miscible organic solvent mentioned in this paragraph is isopropanol. It should however be noted that it is not required that the water-soluble polymer be soluble in a water-soluble or water-miscible organic solvent, nor is it required that a water-soluble or water-miscible organic solvent be employed even if the water-soluble polymer is also soluble in a water-soluble or water-miscible organic solvent. On the other hand, in some cases, a water-soluble or water-miscible organic solvent is employed and water is not employed, even though the polymer is water-soluble.

As to the chemical identity of the water-soluble polymer, it can be selected from a wide variety of polymers including polymeric surfactants, polyelectrolytes such as polyanions, polycations, and polyzwitterions, and polar polymers. The water-soluble polymer may be selected from PVP and PEO, with PEO being somewhat more commonly employed.

The water-soluble polymer and the gum particles can in principle be in any ratio in the film. In some embodiments, the ratio of polymer to gum (w/w) is no less than about 1:200 and no more than about 2:1, optionally no less than about 1:100 and no more than about 1:1, such as no less than about 1:50 and no more than about 1.5:1, or no less than about 1:100 and no more than about 1:1, or no less than about 1:40 and no more than about 1:1. A variety of molecular weights of the water-soluble polymer can be employed. The molecular weight will mostly depend on factors relating to how the film is made, which is discussed in detail below.

In some embodiments, the water-soluble polymer and the gum particles may be in any ratio in the film. For example, the ratio of polymer to gum (w/w) is from about 1:200 to about 2:1, from about 1:100 to about 1:1, from about 1:50 to about 1.5:1, from about 1:100 to about 1:1, or from about 1:40 to about 1:1.

The water-soluble polymer contacts at least a surface of the gum particles. Depending on the ratio of the water-soluble polymer to the gum particles, the gum particles can be partially or completely entrained in a matrix of the water-soluble polymer. The gum particles can be partially entrained in a water-soluble polymer matrix when, for example, at least a portion of the gum particles are completely surrounded by the matrix. The gum particles can be completely entrained by the matrix when more than half of the gum particles, and in some cases essentially all (i.e., no less than about 80%, no less than about 85%, no less than about 90%, no less than about 95%, or even no less than about 99%) of the gum particles, are completely surrounded by the matrix. The gum particles may be entrained by the matrix from about 80% to about 99%, from about 85% to about 95%, or about 90%.

The water-soluble polymer may be a partial or complete coating on the surface of the gum particles (e.g., water-soluble coated gum particles). The particles can, in some cases, also be partially or completely entrained in a matrix of the water-soluble polymer. Itis not necessary for the water-soluble polymer to be present as a matrix, because at least some of the desired results can be achieved when the water-soluble polymer merely contacts at least a part of a surface of the water-organic solvent mixture or organic solvent insoluble gum particles.

It is possible for additional components to be included in the film. For example, when the film is to be used as part of a culture device, one or more of nutrients (for one or more microorganisms), indicator compounds such as dies and more particularly such as redox dies, and selective agents such as antibiotics can be included.

### Articles

Articles comprising any of the films discussed above may include a substrate comprising a first major surface and any of the films discussed above that contacts at least a portion of the first major surface of the substrate. Any suitable substrate can be used, so long as the film laminates well enough to the substrate to maintain its integrity until use. The substrate may be plastic, metal, or glass. Plastic is most common.

The one or more portions of the first major surface that contacts the film can be the outermost of one or more layers of the substrate, and do not necessarily have an adhesive on the first major surface of the substrate. This is because in many cases the film can laminate to the substrate during the coating process without the need for an adhesive on the film. In other cases, the one or more portions of the first major surface that contact the film can include an adhesive on the first major surface of the substrate. Note that, for purposes of this disclosure and the accompanying claims, the first major surface is considered to contact the film even if an adhesive layer, such as an adhesive film, is present on all or part of the first major surface of the substrate, because in this case the adhesive layer or film is considered to be part of the first major surface of the substrate. While it can be advantageous to omit the adhesive when it is not needed because the cost of the article can be lower or it can be easier to manufacture without the adhesive, in many cases adhesive is used to improve the durability or shelf life of the article, to ensure complete and repeatable adhesion between the film and the first major surface, or for other considerations.

When the article is a cell culture device, such as a thin film culture device, the film is may be disposed within a growth compartment of the thin film culture device.

### Method of Making

The film can be made by any suitable method. For example, the plurality of water-soluble gum particles is dispersed in water, at least one water-soluble organic solvent, more particularly at least one water-miscible organic solvent, or a mixture of water and at least one water-soluble organic solvent. The water-soluble organic solvent is in most cases one discussed herein with reference to the water-soluble polymer. Most commonly, when water and at least water-soluble organic solvent are employed, they are in a single-phase mixture; however, in cases where the at least one water-soluble organic solvent is not miscible in water it is possible that a two-phase mixture could be employed. A mixed solvent system with water and at least one water-soluble organic solvent is generally necessary when the at least one water-soluble polymer is insufficiently soluble in a water-free system. Organic solvent alone can be used when the at least one water-soluble polymer is soluble in the organic solvent alone; however, even in this case it may be desirable to use a mixed solvent system to decrease the amount of organic solvent that is used in the process.

In some embodiments, the percent solids of the plurality of water-soluble gum particles is no less than about 5 wt. % and no more than about 60 wt. %, such as no less than about 5 wt. %, no less than about 10 wt. %, no less than about 20 wt. %, no less than about 15 wt. %, no less than about 30 wt. %, or no less than about 40 wt. % (regardless of the solvent system used). In further embodiments, the percent solids of the plurality of water-soluble gum particles is no more than about 50 wt. %, no more than about 40 wt. %, no more than about 30 wt. %, no more than about 25 wt. %, no more than about 20 wt. %, no more than about 15 wt. %, or even no more than about 10 wt. %.

In some embodiments, the percent solids of the plurality of water-soluble gum particles is from about 5 wt. % to about 50 wt. %, about 5 wt. %, about 10 wt. %, about 15 wt. %, about 20 wt. %, about 25 wt. %, about 30 wt. %, about 35 wt. %, about 40 wt. %, about 45 wt. %, or about 50 wt. %.

The at least one water-soluble polymer, which is usually also soluble in a mixture of water and an organic solvent and in some cases is soluble in organic solvent alone, is then added to the dispersion, and may be dissolved in the dispersion. The addition of the water-soluble polymer and the addition of the gum particles can be sequentially in any order, or the water-soluble polymer and gum particles can be added at the same time. If any additional agents are to be included in the film, they can also be added to the dispersion either as dissolved solutes or as dispersed particles.

The organic solvent is at least partially dissolved in the water. The process may be a single-phase process where no separate solvent phase is present. In some cases it may be possible to conduct the process in a multi-phase system, such as an emulsion system.

In some cases, it can be beneficial to agitate the resulting dispersion of the dissolved water-soluble polymer and the dispersed gum particles, for example from about 1 minute to about 1 hour, in order to break up any agglomerated particles. In some embodiments, the resulting dispersion of the dissolved water-soluble polymer and dispersed gum particles are agitated from about 2 minutes to about 55 minutes, from about 3 minutes to about 50 minutes, from about 4 minutes to about 45 minutes, from about 5 minutes to about 40 minutes, from about 10 minutes to about 35 minutes, from about 15 minutes to about 30 minutes, or from about 20 minutes to about 25 minutes. When agitation is performed, it may be performed by hand or by using standard laboratory equipment such as stirrers, rollers, or shakers. It is not always necessary to agitate the dispersion, because agglomeration does not always occur.

The ratio of the water-soluble polymer to the gum particles is the same as the ratio in the resulting film. The ratios discussed herein in relation to the film.

Any suitable concentration of the water-soluble polymer can be used. The concentration is limited by the solubility of the water-soluble polymer in the mixture of water and organic solvent or organic solvent, by the viscosity of the dispersion or solution of water-soluble polymer because when the viscosity is too high then the resulting liquid can be difficult to process or coat onto the substrate, or by a combination of solubility and viscosity. The molecular weight of the water-soluble polymer can also vary. Without wishing to be limited by any particular theory, as the molecular weight of the water-soluble polymer increases, the solution viscosity at the same concentration of polymer (mass/mass) increases. To what extent this is true depends on the nature of the polymer. Thus, while the molecular weight and concentration of the water-soluble polymer can vary, the combination of molecular weight and concentration of the water-soluble polymer are selected such that the water-soluble polymer is dissolved. Examples of suitable molecular weights include no less than about 100 kD and no more than about 7,000 kD. For instance, molecular weights in a range of about 100 kD to about 7000 kD may be used. In some embodiments, molecular weights include no less than about 100 kD, no less than about 1,000 kD, no less than about 2,000 kD, no less than about 4,000 kD, or no less than about 5,000 kD, may be used. Other exemplary molecular weights are no more than about 7,000 kD, no more than about 5,000 kD, no more than about 4,000 kD, no more than about 2,000 kD, and no more than about 1,000 kD. These molecular weights, however, are only exemplary and other molecular weight can also be used so long as the ultimate viscosity is acceptable.

Concentrations of the water-soluble polymer is no less than about 0.25 wt. % and no more than about 20 wt. %. For example, the concentration of the water-soluble polymer may be in a range of about 0.25 wt. % to about 20 wt. %. In some embodiments, the concentration may be no less than about 0.5 wt. %, no less than about 1 wt. %, no less than about 5 wt. %, no less than about 10 wt. %, no less than about 15 wt. %, no more than about 20 wt. %, no more than about 15 wt. %, no more than about 12.5 wt. %, no more than about 10 wt. %, or no more than about 5 wt. %.

In some embodiments, the molecular weight of the water-soluble polymer may be from about 100 kD to about 7,000 kD. In some embodiments, the molecular weight may be in the range of about 1000 kD to about 7,000 kD, 2000 kD to about 5,000 kD, 3000 kD to about 5,000 kD, about 500kD, about 1,000 kD, about 2,000 kD, about 3,000kD, about 4,000 kD, or about 5,000 kD.

In some embodiments, the concentrations of the water-soluble polymer is from about 0.25 wt. % to about 20 wt. %. In further embodiments, the concentration is about 0.25 wt. %, about 0.5 wt. %, about 1 wt. %, about 5 wt. %, about 10 wt. %, about 12.5 wt. %, about 15 wt. %, or about 20 wt. %.

The resulting dispersion can then be solvent coated onto a substrate, such as plastic, glass, and the like. Any suitable solvent coating method can be used, depending on the desired features of the product. Examples coating methods include dye coating, knife coating, solvent casting, and spin coating. Solvent coating is possible because the dispersion's viscosity does not increase with the addition of a suitable concentration of gum particles.

The viscosity of the dispersion is no less than about 200 cP and no more than about 10,000 cP. For example, the viscosity of the dispersion may be about 200 cP to about 10,000 cP. In some embodiments, the viscosity of the dispersion is about 1000 cP to about 10,000 cP, 200 cP to about 1,000 cP, 1000 cP to about 5,000 cP, or 4000 cP to about 10,000 cP.

In some embodiments, the resulting dispersion has a viscosity to facilitate coating the dispersion on a substrate. For instance, the dispersion is pumpable, i.e., the dispersion has a viscosity such that the dispersion may be fed through a nozzle.

After coating, the article can be dried to remove water and organic solvent. The drying step may be done to constant mass, but this is not always required depending on the desired properties of the final product.

The total coat weight of the dried film may be in the range of about 500 mg/24 in² to about 2500 mg/24 in². In some embodiments, the total coat weight is from about 600 mg/24 in² to about 2400 mg/24 in², from about 700 mg/24 in² to about 2400 mg/24 in², from about 700 mg/24 in² to about 2000 mg/24 in², from about 800 mg/24 in² to about 2200 mg/24 in², from about 900 mg/24 in² to about 2100 mg/24 in², from about 1000 mg/24 in² to about 2000 mg/24 in², from about 700 mg/24 in² to about 16000 mg/24 in², from about 1100 mg/24 in² to about 1900 mg/24 in², from about 1200 mg/24 in² to about 1800 mg/24 in², from about 1300 mg/24 in² to about 1700 mg/24 in², from about 1400 mg/24 in² to about 1600 mg/24 in², or from about 500 mg/24 in² to about 1000 mg/24 in².

In some embodiments, the invention pertains to a film comprising:
a pluralities of particles of a water-soluble gum and a water-soluble polymer that contacts at least part of a surface of the water soluble gum particles, wherein the film has a total coat weight in the range of about 500 mg/24 in² to about 2500 mg/24 in².

In further embodiments, the invention pertains to a film comprising:
a pluralities of particles of guar gum and a water-soluble polymer that contacts at least part of a surface of the guar gum particles, wherein the film has a total coat weight in the range of about 500 mg/24 in² to about 2500 mg/24 in² or about 700 mg/24 in² to about 2400 mg/24 in² or about 700 mg/24 in² to about 2000 mg/24 in².

In further embodiments, the invention pertains to a film comprising:
a pluralities of particles of guar gum and PVP that contacts at least part of a surface of the guar gum particles, wherein the film has a total coat weight in the range of about 500 mg/24 in² to about 2500 mg/24 in² or about 700 mg/24 in² to about 2400 mg/24 in² or about 700 mg/24 in² to about 2000 mg/24 in².

In further embodiments, the invention pertains to a film comprising:
a pluralities of particles of guar gum and PEO that contacts at least part of a surface of the guar gum particles, wherein the film has a total coat weight in the range of about 500 mg/24 in² to about 1500 mg/24 in² or from about 500 mg/24 in² to about 1000 mg/24 in².

Without wishing to be limited to any particular theory, one advantage of the invention is the prevention of the phenomenon of gel-blocking in dispersion-coated substrates or films. Gel-blocking is a phenomenon which occurs wherein a top layer of the dispersion-coated substrate or film is fully swollen or gelled upon rehydration which creates a gel-block on the top layer and prevents a full rehydration of the dispersion-coated substrate or film.

Another advantage of the invention is that resulting films prepared by methods encompassed by the invention] are able to attain high total coat weight while maintaining optimal swelling or gelling property of the dispersed gum particles.

### Methods of Using

When the article is a cell culture device, such as a thin film culture device, it can be used in the same manner as conventional cell culture devices that are made by prior-art methods and that lack the water-soluble polymer. The water-soluble nature of the water-soluble polymer means that, when the film portion of the cell culture device is contacted with an aqueous sample comprising one or more microorganism to form an inoculated article, the water-soluble polymer will dissolve allowing the water in the aqueous sample to hydrate the gum particles.

The inoculated article can then be incubated for a time period sufficient for the microorganism to undergo at least one reproduction and detecting the presence of the microorganism. The incubation time can vary greatly depending on the type of microorganism and the temperature. Exemplary incubation times are disclosed, for example, in U.S. Pat. Nos. 5,869,321, 9,988,600, and US202001943. After incubation, the one or more microorganisms can be detected or enumerated by any suitable means. For example, the Petrifilm™ Plate Reader Advanced (available from 3M Company, St Paul MN) is a commercially available device for enumerating thin film culture plates, such as those available under the Petrifilm™ brand name (also from 3M Company).

### EXAMPLES

### Materials

BACTO Tryptic Soy Broth (TSB) was obtained from Becton, Dickinson and Company, Franklin Lakes, NJ. Butterfield's Buffer was obtained from the 3M Company, Maplewood, MN. 2,3,5-Triphenyl Tetrazolium Chloride (TTC) was obtained from the MilliporeSigma Company, St. Louis, MO. Isopropanol (IPA) was obtained from VWR International, Radnor, PA.

Polyvinylpyrrolidone (PVP), K90 grade, was obtained from Ashland Incorporated, Wilmington, DE.

POLYOX WSR 301 polyethylene oxide (PEO) polymer (4,000,000 g/mol), POLYOX WSR 303 polyethylene oxide (PEO) polymer (7,000,000 g/mol), POLYOX WSR Nl2K polyethylene oxide (PEO) polymer (1,000,000 g/mol), and POLYOX WSR N60K polyethylene oxide (PEO) polymer (2,000,000 g/mol) were obtained from DuPont, Wilmington, DE).

Guar Gum (Meyprogat 150) was obtained from Danisco, Copenhagen, Denmark. The guar gum was sterilized with ethylene oxide and thoroughly aerated to remove to remove residual sterilant.

Unless otherwise noted, water was obtained from a MILLI-Q water purification system (EMD Millipore, Billerica, MA).

### Preparatory Example 1. Inoculum Preparation

The bacterial strains Escherichia coli (ATCC 25922), Escherichia coli (ATCC 8739), Escherichia coli (ATCC 51813), Staphylococcus aureus (ATCC 25923), Staphylococcus aureus (ATCC 6538), Acinetobacter sp. (ATCC 51819), and Chryseobaterium shigense (ATCC 51823) were obtained from Microbiologics, Incorporated (St. Cloud, MN) or from VWR International and individually incubated overnight in tryptic soy broth (TSB) at 37° C. and 200 rpm in an INNOVA44 incubator (New Brunswick Scientific, Enfield, CT). Each inoculum was prepared by serially diluting a single culture sample with Butterfield's Buffer. Each culture sample was diluted to yield a final concentration of about 50-250 colony forming unit (cfu) counts per 1 mL of inoculum.

### Examples 1-24. Dispersion Formulations of Guar Gum, PVP (K90), and Isopropanol

Twenty-four individual formulations were prepared using varying amounts (in grams) of the components as listed in Table 1. For each formulation, isopropanol (IPA) and PVP (K90) were added to a glass jar (4 ounce) and mixed with a magnetic stir bar until the PVP dissolved. Guar gum was then added to the jar and the mixture was stirred with a magnetic stir bar for 30 minutes, followed with additional mixing by placing the capped jar on a laboratory roller. Mixing using the roller was continued for at least one hour in order to remove large, visible aggregates.

TABLE 1

| Example | Isopropanol (g) | PVP (g) | Guar Gum (g) |
|---|---|---|---|
| 1 | 42 | 8 | 8.8 |
| 2 | 42 | 8 | 11.75 |
| 3 | 42 | 8 | 17.65 |
| 4 | 45 | 5 | 8.8 |
| 5 | 45 | 5 | 12.5 |
| 6 | 45 | 5 | 21.4 |
| 7 | 45 | 5 | 33.4 |
| 8 | 47.5 | 2.5 | 8.8 |
| 9 | 47.5 | 2.5 | 12.5 |
| 10 | 47.5 | 2.5 | 21.4 |
| 11 | 47.5 | 2.5 | 33.4 |
| 12 | 29 | 1 | 20 |
| 13 | 50 | 2.23 | 12.63 |
| 14 | 50 | 3.85 | 21.87 |
| 15 | 50 | 6.1 | 34.5 |
| 16 | 50 | 1.02 | 12.63 |
| 17 | 50 | 1.78 | 21.87 |
| 18 | 50 | 2.8 | 34.5 |
| 19 | 50 | 0.66 | 12.63 |
| 20 | 50 | 1.14 | 21.87 |
| 21 | 50 | 1.8 | 34.5 |
| 22 | 50 | 0.33 | 12.63 |
| 23 | 50 | 0.57 | 21.87 |
| 24 | 50 | 0.9 | 34.5 |

### Examples 25-34. Dispersion Formulations of Guar Gum, POLYOX WSR Nl2K PEO Polymer, Isopropanol, and Water

Ten individual formulations were prepared using varying amounts (in grams) of the components as listed in Table 2. For each formulation, isopropanol and POLYOX WSR Nl2K polyethylene oxide polymer was added to a glass jar (16 ounce) and mixed with a magnetic stir bar until the polymer was dispersed. Water was added to the jar and the contents were mixed with a magnetic stir bar for 1 hour. If the polymer had not fully dissolved, the capped jar was placed on a laboratory roller until the polymer had dissolved. Guar gum was then added to the jar and the jar was first shaken by hand, followed with additional mixing by placing the capped jar on a laboratory roller for at least one hour. Mixing using the roller was continued for at least one hour in order to remove large, visible aggregates.

TABLE 2

| | | POLYOX WSR | | |
|---|---|---|---|---|
| | | Nl2K PEO | | Guar Gum |
| Example | Isopropanol (g) | Polymer (g) | Water (g) | (g) |
| 25 | 37.52 | 2.1 | 9.38 | 21 |
| 26 | 43.68 | 1.4 | 10.92 | 14 |
| 27 | 38.36 | 1.05 | 9.59 | 21 |
| 28 | 44.24 | 0.7 | 11.06 | 14 |
| 29 | 38.78 | 0.525 | 9.695 | 21 |
| 30 | 44.52 | 0.35 | 11.13 | 14 |
| 31 | 38.22 | 1.4 | 16.38 | 14 |
| 32 | 32.76 | 1.4 | 21.84 | 14 |
| 33 | 27.3 | 1.4 | 27.3 | 14 |
| 34 | 21.84 | 1.4 | 32.76 | 14 |

### Examples 35-36. Dispersion Formulations of Guar Gum, POLYOX WSR N60K PEO Polymer, Isopropanol, and Water

The same procedure as reported in Examples 25-34 was followed with the exception that in the formulations POLYOX WSR Nl2K polyethylene oxide polymer was replaced with POLYOX N60K polyethylene oxide polymer. Two formulations were prepared using varying amounts (in grams) of the components as listed in Table 3.

TABLE 3

| | | POLYOX | | |
|---|---|---|---|---|
| | | WSR N60K | | |
| | | PEO Polymer | | Guar Gum |
| Example | Isopropanol (g) | (g) | Water (g) | (g) |
| 35 | 38.36 | 1.05 | 9.59 | 21 |
| 36 | 44.24 | 0.7 | 11.06 | 14 |

### Examples 37-38. Dispersion Formulations of Guar Gum, POLYOX WSR 301 PEO Polymer, Isopropanol, and Water

The same procedure as reported in Examples 25-34 was followed with the exception that in the formulations POLYOX WSR Nl2K polyethylene oxide polymer was replaced with POLYOX WSR 301 polyethylene oxide polymer. Two formulations were prepared using varying amounts (in grams) of the components as listed in Table 4.

TABLE 4

| | | POLYOX WSR | | |
|---|---|---|---|---|
| | | 301 PEO Polymer | | Guar Gum |
| Example | Isopropanol (g) | (g) | Water (g) | (g) |
| 37 | 38.78 | 0.525 | 9.695 | 21 |
| 38 | 44.52 | 0.35 | 11.13 | 14 |

### Examples 39-42. Dispersion Formulations of Guar Gum, POLYOX WSR 303 PEO Polymer, TSB, Isopropanol, and Water

Four individual formulations were prepared using varying amounts (in grams) of the components as listed in Table 5. For each formulation, isopropanol and POLYOX WSR 303 polyethylene oxide polymer were added to a glass jar (16 ounce) and mixed with a magnetic stir bar until the polymer was dispersed. Water was added to the jar and the contents were mixed with an IKA Eurostar 60 overhead stirrer equipped with a 4-blade impeller (IKA Works, Wilmington, NC) until the polymer dissolved. TSB powder was added to the solution followed by mixing with the overhead stirrer until the dispersion was uniform in color and consistency. Guar gum was then added to the jar and the contents were stirred with the overhead stirrer until the dispersion was uniform in color and consistency.

TABLE 5

| | | POLYOXWSR | | | |
|---|---|---|---|---|---|
| | Isopropanol | 303 PEO | Water | TSB | Guar Gum |
| Example | (g) | Polymer (g) | (g) | (g) | (g) |
| 39 | 92.5 | 0.9 | 39.6 | 7 | 60 |
| 40 | 106.5 | 0.9 | 45.6 | 7 | 40 |
| 41 | 87.6 | 0.8 | 37.6 | 14 | 60 |
| 42 | 101.6 | 0.9 | 43.5 | 14 | 40 |

### Examples 43-53. Films Prepared by Coating Formulations of Examples 1-12 Onto a PET Substrate

Twelve separate films were prepared by coating a single formulation selected from the formulations of Examples 1-12 onto the surface of a polyethylene terephthalate (PET) film substrate (3.8 mil (0.1 mm) thick). Each PET substrate sample was coated using a 14 mil (0.35 mm) wet gap and a notch bar. The coated films were placed in an oven set at 85 ° C. for 12 minutes. The total coat weights (g/24 in²) of the resulting dried film were determined and the coat weights of the individual components (PVP and guar gum) of each film were also calculated based on the weights of the individual components (PVP and guar gum) in the coating formulation. The results are reported in Table 6.

TABLE 6

| | | Total Coat | PVP Coat | Guar Gum |
|---|---|---|---|---|
| | Formulation | Weight | Weight | Coat Weight |
| Example | of Example | (mg/24 in²) | (mg/24 in²) | (mg/24 in²) |
| 43 | 1 | 1035 | 493 | 542 |
| 44 | 2 | 1197 | 485 | 712 |
| 45 | 3 | 1650 | 515 | 1135 |
| 46 | 4 | 883 | 320 | 563 |
| 47 | 5 | 1062 | 303 | 759 |
| 48 | 6 | 1474 | 279 | 1195 |
| 49 | 7 | 1980 | 258 | 1722 |
| 50 | 8 | 669 | 148 | 521 |
| 51 | 9 | 834 | 139 | 695 |
| 52 | 10 | 1300 | 136 | 1164 |
| 53 | 11 | 1734 | 121 | 1613 |
| 54 | 12 | 1688 | 80 | 1608 |

### Examples 55-66. Films Prepared by Coating Formulations of Examples 13-24 Onto a BOPP Substrate

A biaxially-oriented polypropylene (BOPP) film (1.6 mil (0.04 mm) thick) having a pressure sensitive adhesive [isooctyl acrylate/acrylic acid (98/2 weight ratio) with TTC indicator] laminated on one surface was prepared according to the procedure described in Example 4 of U.S. Pat. No. 5,409,838 (Wickert).

Twelve separate films were prepared by coating a single formulation selected from the formulations of Examples 13-24 onto the adhesive surface of the BOPP film substrate. Each BOPP substrate sample was coated using a 14 mil (0.35 mm) wet gap and a notch bar. The coated films were placed in an oven set at 85° C. for 12 minutes. The total coat weights (g/24 in²) of the resulting dried films were determined and the coat weights of the individual components (PVP and guar gum) of each film were also calculated based on the weights of the individual components (PVP and guar gum) in the corresponding coating formulation. The results are reported in Table 7.

TABLE 7

| | | Total Coat | PVP Coat | Guar Gum |
|---|---|---|---|---|
| | Formulation | Weight | Weight | Coat Weight |
| Example | of Example | (mg/24 in²) | (mg/24 in²) | (mg/24 in²) |
| 55 | 13 | 876 | 131 | 745 |
| 56 | 14 | 1420 | 213 | 1207 |
| 57 | 15 | 1860 | 279 | 1581 |
| 58 | 16 | 906 | 68 | 838 |
| 59 | 17 | 1204 | 91 | 1113 |
| 60 | 18 | 1860 | 140 | 1720 |
| 61 | 19 | 744 | 37 | 707 |
| 62 | 20 | 1176 | 58 | 1118 |
| 63 | 21 | 1728 | 86 | 1642 |
| 64 | 22 | 736 | 19 | 717 |
| 65 | 23 | 1106 | 28 | 1078 |
| 66 | 24 | 2314 | 59 | 2255 |

### Examples 67-76. Films Prepared by Coating Formulations of Examples 25-34 Onto a PET Substrate

Ten separate films were prepared by coating a single formulation selected from the formulations of Examples 25-34 onto the surface of a PET film substrate (3.8 mil (0.1 mm) thick). Each PET substrate sample was coated using a 14 mil (0.35 mm) wet gap and a notch bar. The coated films were placed in an oven set at 85° C. for 12 minutes. The total coat weights (g/24 in²) of the resulting dried films were determined and the coat weights of the individual components (PEO and guar gum) of each film were also calculated based on the weights of the individual components (PEO and guar gum) in the corresponding coating formulation. The results are reported in Table 8.

TABLE 8

| | | | POLYOX WSR | |
|---|---|---|---|---|
| | | Total Coat | Nl2K PEO Coat | Guar Gum |
| | Formulation | Weight | Weight | Coat Weight |
| Example | of Example | (mg/24 in²) | (mg/24 in²) | (mg/24 in²) |
| 67 | 25 | 1550 | 141 | 1409 |
| 68 | 26 | 858 | 78 | 780 |
| 69 | 27 | 1170 | 56 | 1114 |
| 70 | 28 | 806 | 38 | 768 |
| 71 | 29 | 1332 | 32 | 1300 |
| 72 | 30 | 702 | 17 | 685 |
| 73 | 31 | 864 | 79 | 785 |
| 74 | 32 | 898 | 82 | 816 |
| 75 | 33 | 920 | 84 | 836 |
| 76 | 34 | 922 | 84 | 838 |

### Examples 77-78. Films Prepared by Coating Formulations of Examples 35-36 Onto a PET Substrate

Two separate films were prepared by coating a single formulation selected from the formulations of Examples 35 and 36 onto a PET film substrate (3.8 mil (0.1 mm) thick). Each PET substrate sample was coated using a 14 mil (0.35 mm) wet gap and a notch bar. The coated films were placed in an oven set at 85° C. for 12 minutes. The total coat weights (g/24 in²) of the resulting dried films were determined and the coat weights of the individual components (PEO and guar gum) of each film were also calculated based on the weights of the individual components (PEO and guar gum) in the corresponding coating formulation. The results are reported in Table 9.

TABLE 9

| | | | POLYOX WSR | |
|---|---|---|---|---|
| | | Total Coat | N60K PEO Coat | Guar Gum |
| | Formulation | Weight | Weight | Coat Weight |
| Example | of Example | (mg/24 in²) | (mg/24 in²) | (mg/24 in²) |
| 77 | 35 | 1242 | 59 | 1183 |
| 78 | 36 | 696 | 33 | 663 |

### Examples 79-80. Films Prepared by Coating Formulations of Examples 37-38 Onto a PET Substrate

Two separate films were prepared by coating a single formulation selected from the formulations of Examples 37 and 38 onto a PET film substrate (3.8 mil (0.1 mm) thick). Each PET substrate sample was coated using a 14 mil (0.35 mm) wet gap and a notch bar. The coated films were placed in an oven set at 85° C. for 12 minutes. The total coat weights (g/24 in²) of the resulting dried films were determined and the coat weights of the individual components (PEO and guar gum) of each film were also calculated based on the weights of the individual components (PEO and guar gum) in the corresponding coating formulation. The results are reported in Table 10.

TABLE 10

| | | | POLYOX WSR | |
|---|---|---|---|---|
| | | Total | 301 PEO Coat | Guar Gum |
| | Formulation | Coat Weight | Weight | Coat Weight |
| Example | of Example | (mg/24 in²) | (mg/24 in²) | (mg/24 in²) |
| 79 | 37 | 792 | 19 | 773 |
| 80 | 38 | 734 | 18 | 716 |

### Examples 81-84. Films Prepared by Coating Formulations of Examples 39-42 Onto a BOPP Substrate

Four separate films were prepared by coating a single formulation selected from the formulations of Examples 39 to 42 onto the adhesive surface of the BOPP film substrate described in Examples 55-66. Each BOPP substrate sample was coated using a 14 mil (0.35 mm) wet gap and a notch bar. The coated films were placed in an oven set at 85° C. for 12 minutes. The total coat weights (g/24 in²) of the resulting dried films were determined and the coat weights of the individual components (PEO, guar gum, and TSB) of each film were also calculated based on the weights of the individual components (PEO, guar gum, and TSB) in the corresponding coating formulation. The results are reported in Table 11.

TABLE 11

| | | | POLYOX | | |
|---|---|---|---|---|---|
| | | | WSR 303 | Guar Gum | |
| | | Total Coat | PEO Coat | Coat | TSB Coat |
| | | Weight | Weight | Weight | Weight |
| | Formulation | (mg/24 | (mg/24 | (mg/24 | (mg/24 |
| Example | of Example | in²) | in²) | in²) | in²) |
| 81 | 39 | 1057 | 14 | 934 | 109 |
| 82 | 40 | 611 | 12 | 510 | 89 |
| 83 | 41 | 908 | 10 | 728 | 170 |
| 84 | 42 | 612 | 10 | 446 | 156 |

### Example 85. Preparation of Thin Film Culture Devices

The coated BOPP film substrates of Examples 81-84 were cut into 76 mm wide by 102 mm long sections. The cover sheets (76 mm wide by 102 mm long) were removed from PETRIFILM Aerobic Count Plates (obtained from the 3M Corporation, Maplewood, MN). Thin film culture devices were assembled by attaching a cover sheet to a coated film substrate (in a hinge-like fashion) along one edge (the 76 mm edge) of the coated film using double sided adhesive tape. For each device, the cover sheet and the substrate were oriented so that the edges were aligned and the guar coated surface of the cover sheet faced the coated surface on the coated film substrate.

### Example 86. Colony Count Using Devices of Example 85

Finished thin film culture devices of Example 85 were inoculated with an inoculum of either Escherichia coli (ATCC 25922), Escherichia coli (ATCC 8739), Escherichia coli (ATCC 51813), Staphylococcus aureus (ATCC 25923), Staphylococcus aureus (ATCC 6538), Acinetobacter sp. (ATCC 51819), or Chryseobaterium shigense (ATCC 51823). The devices were placed on a flat, horizontal surface. The cover sheet of each device was lifted and 1 mL of a single inoculum (i.e., final dilution described in Preparatory Example 1) was carefully added by pipette as a single application to a compact region in the center of the coated substrate. The cover sheet was gently returned to its original position. A 3M PETRIFILM Spreader (obtained from the 3M Company) was applied to the external surface of the cover sheet to spread the inoculum so that it formed a circular region having a diameter of about 2 inches (5.1 cm). Each device was incubated at 32° C. for 48 hours. At the end of the incubation period, the devices were evaluated for bacteria colony formation. Red colored, punctate colonies disposed across the surface of each device were counted by visual examination. The results are presented in Table 12 as the mean colony count (cfu/mL) from two trials (n=2). As a control, the inocula were also analyzed using 3M PETRIFILM Aerobic Count Plates according to the manufacturer's instructions. The mean colony counts (cfu/mL) using the control plates (n=2) are reported in Table 12.

TABLE 12

| | Colony Count (cfu/mL) | | | | |
|---|---|---|---|---|---|
| | Coated Film Used in Thin Film Culture Device | | | | |
| | Example | Example | Example | Example | |
| Inoculum | 81 | 82 | 83 | 84 | Control |
| E. coli | 74 | 84 | 61 | 70 | 68 |
| (ATCC 25922) | | | | | |
| E. coli | 82 | 84 | 92 | 91 | 75 |
| (ATCC 8739) | | | | | |
| E. coli | 85 | 84 | 79 | 76 | 77 |
| (ATCC 51813) | | | | | |
| S. aureus | 75 | 79 | 67 | 57 | 66 |
| (ATCC 25923) | | | | | |
| S. aureus | 66 | 78 | 122 | 95 | 66 |
| (ATCC 6538) | | | | | |
| Acinetobacter | 49 | 41 | 51 | 47 | 41 |
| sp. | | | | | |
| (ATCC 51819) | | | | | |
| C. shigense | 101 | 101 | 102 | 111 | 109 |
| (ATCC 51823) | | | | | |

### LIST OF EMBODIMENTS

The following is a non-limiting list of embodiments:
1. A film comprising:
a pluralities of particles of a water-soluble gum and a water-soluble polymer that contacts at least part of a surface of the water soluble gum particles, wherein the film has a total coat weight in the range of about 500 mg/24 in² to about 2500 mg/24 in² or about 700 mg/24 in² to about 2400 mg/24 in² or about 700 mg/24 in² to about 2000 mg/24 in².
2. The film of embodiment 1, wherein the water-soluble polymer is also soluble in a solution of water and a water-soluble organic solvent, the water-soluble organic solvent optionally selected from the group consisting of isopropanol, ethanol, methanol, tetrahydrofuran, diethyl ether, methyl ethyl ether, dimethyl ether, and acetone, wherein the water-soluble organic solvent is further optionally selected from the group consisting of isopropanol, ethanol, and methanol, and even further optionally wherein the water-soluble organic solvent is isopropyl alcohol.
3. The film of any of the preceding embodiments, wherein the polymer is selected from PEO and PVP.
4. The film of any of the preceding embodiments, wherein the water-soluble gum is able to gel when contacted with cold water.
5. The film of any of the preceding embodiments, wherein the gum is selected from guar gum, locust bean gum, and xanthan gum, and optionally wherein the gum is guar gum.
6. The film of any of the preceding embodiments, wherein at least some of the particles of the water-soluble gum are completely entrained by the water-soluble polymer.
7. The film of any of the preceding embodiments, wherein the ratio of polymer to gum is no less than about 1:200 and no more than about 2:1, optionally no less than about 1:=100 and no more than about 1:1.
8. An article comprising a substrate and the film of any of the preceding embodiments that contacts at least a portion of a first major surface of the substrate, wherein the substrate comprises at least one of plastic, metal, or glass, and preferably wherein the substrate comprises plastic.
9. The article of embodiment 8, wherein the portion of the first major surface of the substrate that contacts the film does not have an adhesive.
10. The article of embodiment 8 or 9, wherein the film is disposed in a growth compartment of a thin film culture device.
11. The article of any of embodiments 8-10, wherein the film further comprises at least one nutrient for facilitating the growth of at least one microorganism.
12. The article of any of embodiments 8-11, wherein the film further comprises at least one dye, optionally at least one redox dye.
13. A method of making an article, comprising:
forming a dispersion by:
   dispersing particles of at least one water-soluble gum in a liquid containing water, at least one water soluble organic solvent, or a mixture of water and at least one organic solvent, and
   dissolving at least one water-soluble polymer in the liquid containing water, at least one water soluble organic solvent, or a mixture of water and at least one organic solvent to form a dispersion of the particles of at least one water-soluble gum and at least one water-soluble polymer in the liquid,
      and
   solvent coating the dispersion onto a substrate to form a film on the substrate; wherein the article is optionally an article of any of embodiments 8-12; and wherein the film is optionally a film of any of embodiments 1-7.
14. The method of embodiment 13, further comprising drying the article to constant mass.
15. The method of any of embodiments 13-14, wherein the at least one organic solvent comprises, or optionally is, one or more of isopropanol, ethanol, methanol, tetrahydrofuran, diethyl ether, methyl ethyl ether, dimethyl ether, and acetone, wherein the water-soluble organic solvent is further optionally selected from the group consisting of isopropanol, ethanol, and methanol, and even further optionally wherein the water-soluble organic solvent is isopropyl alcohol.
16. The method of any of embodiments 13-15, wherein the polymer is PEO, PVP, or a mixture thereof.
17. The method of any of embodiments 13-16, wherein the ratio of the water to the water-soluble organic solvent is from about 2:1 to about 1:5.
18. The method of any of embodiments 13-17, wherein the dispersed gum particles are present in the dispersion at a solids concentration (wt/v) between about 5 and about 50%, or about.
19. The method of any of embodiments 13-18, wherein the concentration of dissolved polymer in the dispersion (wt/v) is from about 20% to about 0.25%.
20. A method of using an article of any of embodiments 8-12, comprising contacting the article with an aqueous sample comprising one or more microorganism to form an inoculated article, incubating the inoculated article for a time period sufficient for the microorganism to undergo at least one reproduction, and detecting the presence of the microorganism.
21. The method of embodiment 20, further comprising enumerating the microorganism.
22. A dispersion comprising
a liquid component that comprises water, a water-soluble organic solvent that is at least partially soluble in the water, or both;
gum particles dispersed in the liquid component, and
a water-soluble polymer dissolved in the liquid component.
23. The dispersion of embodiment 22, wherein the gum particles comprise one or more of guar gum, xanthan gum, or locust bean gum.
24. The dispersion of embodiment 22 or 23, wherein the water-soluble organic solvent is selected from the group consisting of isopropanol, ethanol, methanol, tetrahydrofuran, diethyl ether, methyl ethyl ether, dimethyl ether, and acetone, optionally selected from the group consisting of isopropanol, ethanol, and methanol, and even further optionally wherein the water-soluble organic solvent is isopropyl alcohol.
25. The dispersion of any of embodiments 22-24, wherein the wherein the ratio of water to water-soluble organic solvent is from about 2:1 to about 1:5.
26. The dispersion of any of embodiments 22-25 wherein the dispersed gum is present at a solids concentration (wt/v) of between about 5 and about 60%, or about 30 and about 60%, or about 50 and about 60%..
27. The dispersion of any of embodiments 22-26, wherein the concentration of dissolved polymer (wt/v) is between about 20 and about 0.5%.
28. The dispersion of any of embodiments 22-27, wherein the organic polymer is PEO, PVP, or a mixture thereof.
29. The dispersion of any of embodiments 22-28, wherein the dispersed gum is present at a solids concentration (wt/v) of between about 5 and about 60%..
30. The dispersion of any of embodiments 22-29, wherein the concentration of dissolved polymer (wt/v) is 20 and 0.5%.
31. The dispersion of any of embodiments 22-30, or the method of any of embodiments 12-18, wherein the viscosity of the dispersion is between about 200 and about 10,000 cP.
32. The film of any of embodiments 1-7, or the article of any of embodiments 8-12, wherein the film has a total coat weight is in the range of from about 500 mg/24 in² to about 2500 mg/24 in².
33. The method of any of embodiments 13-19, or the dispersion of any of embodiments 22-31, wherein the dispersion upon drying forms a film with a total coat weight in the range of from about 500 mg/24 in² to about 2500 mg/24 in².

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.

All publications mentioned herein are incorporated by reference to the extent they support the present invention.

1. A film comprising:
a pluralities of particles of a water-soluble gum and a water-soluble polymer that contacts at least part of a surface of the water soluble gum particles, wherein the film has a total coat weight in the range of about 500 mg/24 in² to about 2500 mg/24 in².

2. The film of claim 1, wherein the water-soluble polymer is also soluble in a solution of water and a water-soluble organic solvent, the water-soluble organic solvent optionally selected from the group consisting of isopropanol, ethanol, methanol, tetrahydrofuran, diethyl ether, methyl ethyl ether, dimethyl ether, and acetone, wherein the water-soluble organic solvent is further optionally selected from the group consisting of isopropanol, ethanol, and methanol, and even further optionally wherein the water-soluble organic solvent is isopropyl alcohol.

3. The film of claim 1, wherein the water-soluble polymer is selected from PEO and PVP.

4. (canceled)

5. The film of claim 1, wherein the water-soluble gum is selected from guar gum, locust bean gum, and xanthan gum, and optionally wherein the gum is guar gum.

6. (canceled)

7. The film of claim 1, wherein the ratio of polymer to gum is no less than about 1:200 and no more than about 2:1, optionally no less than about 1:100 and no more than about 1:1.

8. An article comprising a substrate and a film that contacts at least a portion of a first major surface of the substrate, wherein the substrate comprises at least one of plastic, metal, or glass, and preferably wherein the substrate comprises plastic.

9. The article of claim 8, wherein the portion of the first major surface of the substrate that contacts the film does not have an adhesive.

10. The article of claim 8, wherein the film is disposed in a growth compartment of a thin film culture device.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. A dispersion comprising:
a liquid component that comprises water, a water-soluble organic solvent that is at least partially soluble in the water, or both;
gum particles dispersed in the liquid component, and
a water-soluble polymer dissolved in the liquid component.

23. The dispersion of claim 22, wherein the gum particles comprise one or more of guar gum, xanthan gum, or locust bean gum.

24. The dispersion of claim 22, wherein the water-soluble organic solvent is selected from the group consisting of isopropanol, ethanol, methanol, tetrahydrofuran, diethyl ether, methyl ethyl ether, dimethyl ether, and acetone, optionally selected from the group consisting of isopropanol, ethanol, and methanol, and even further optionally wherein the water-soluble organic solvent is isopropyl alcohol.

25. The dispersion of claim 22, wherein the wherein the ratio of water to water-soluble organic solvent is from about 2:1 to about 1:5.

26. The dispersion of claim 22, wherein the dispersed gum is present at a solids concentration (wt/v) of between 50 and 5%.

27. The dispersion of claim 22, wherein the concentration of dissolved polymer (wt/v) is between about 20 and about 0.5%.

28. The dispersion of claim 22, wherein the organic polymer is PEO, PVP, or a mixture thereof.

29. The dispersion of claim 22, wherein the dispersed gum is present at a solids concentration (wt/v) of between 50 and 5%.

30. The dispersion of claim 22, wherein the concentration of dissolved polymer (wt/v) is 20 and 0.5%.

31. The dispersion of claim 22, wherein the viscosity of the dispersion is between about 200 and about 10,000 cP.

32. The film of any of claim 1, wherein the film has a total coat weight is in the range of from about 500 mg/24 in² to about 2500 mg/24 in².

33. The dispersion of claim 22, wherein the dispersion upon drying forms a film with a total coat weight in the range of from about 500 mg/24 in² to about 2500 mg/24 in².
